(19) United States
(12) Patent Application Publication
(10) Pub. No.: US 2018/0088273 A1
(43) Pub. Date: Mar. 29, 2018

(54) DOUBLE-SIDED DISPLAY DEVICE AND LIGHT GUIDE PLATE AND BACK LIGHT THEREOF

(71) Applicant: Shenzhen China Star Optoelectronics Technology Co., Ltd., Shenzhen, Guangdong (CN)

(72) Inventor: Xiaoyu HUANG, Shenzhen, Guangdong (CN)

(73) Assignee: Shenzhen China Star Optoelectronics Technology Co., Ltd., Shenzhen, Guangdong (CN)

(21) Appl. No.: 15/115,626

(22) PCT Filed: May 17, 2016
(86) PCT No.: PCT/CN2016/082310

§ 371 Date: Jul. 29, 2016

(30) Foreign Application Priority Data
Apr. 12, 2016 (CN) 201610224730.9

(51) Int. Cl. G02B 6/12; F21V 8/00; G02F 1/1335; G02F 1/1347

(52) U.S. Cl. CPC G02B 6/12; G02B 6/0053; G02F 1/1347; G02F 1/1335; G02B 6/0088

(57) ABSTRACT

A light guide plate has the reflection section in the middle, the reflection section includes the first reflection surface, the second reflection surface, the third reflection surface and the fourth reflection surface, the reflection surfaces are surrounded end to end to be a close structure and the reflection section completely covers the thickness direction and the lengthwise direction of the light guide plate. Because of the horizontal component emitted by light source module through both sides of the light guide plate in the display device will be changed the transmission direction by the reflection surface, so as to be guided to the both sides of the display panel, and increasing the light utilization emitted by the light source module at least 5%-10%, thus no longer need to raise additional light source brightness, energy-efficient economy, the competitiveness of products have been greatly enhanced.

### BACKGROUND OF THE INVENTION

### Field of the Invention

The present disclosure relates to a display technology field, and more particularly to a double-sided display device and a light guide plate and a back light thereof.

### The Related Arts

Thin film transistor liquid crystal display (TFT-LCD) is currently one of the main technologies of flat panel display and has become the important display platform of modern products of information technology (IT) and video. Since the liquid crystal itself is not light, therefore a back light (BL) is needed.

Currently, a common display structure of the double-sided display technologies for business as shown in FIG. 1, to achieve double-sided display, two display panels 1 share a back light is required, without the conventional back light structure like reflection sheet, brightness and optical energy efficiency of the back light have higher requirements. Wherein, the light emitted by both ends of light emitting diodes (LED) 2 through a light guide plate 3, and then through optical films of both sides of the light guide plate 3, and finally a uniform surface light source is formed for both sides of the display panels 1 to display by mixed light process.

However, the horizontal component in the light emitted by the LED 2 in the conventional double-sided display structure will direct transmitted to contralateral through light guide plate, and can't transmits to display module for display, wasting the optical energy, increasing the back light power indirectly and is not conducive to energy conservation and utilization of the back light.

### SUMMARY OF THE INVENTION

In view of the deficiencies of the prior art, the present disclosure provides a double-sided display device with high light utilization and energy conservation and a light guide plate and a back light thereof.

In order to achieve the above object, the present disclosure is employed:

A light guide plate used for the double-sided display device includes an upper light output surface and a lower light output surface on the thickness direction and a left light input terminal surface and a right light input terminal surface on the lengthwise direction, the light guide plate further includes a reflection section arranged in the middle, the reflection section includes a first reflection surface facing to the upper light output surface and the left light input terminal surface at the same time, a second reflection surface facing on the upper light output surface and the right light input terminal surface at the same time, a third reflection surface facing to the lower light output surface and the left light input terminal surface at the same time and a fourth reflection surface facing to the lower light output surface and the right light input terminal surface at the same time, the first reflection surface, the second reflection surface, the third reflection surface and the fourth reflection surface are surrounded end to end to be a close structure, the reflection section completely covers the thickness direction and the lengthwise direction of the light guide plate.

Further, the first reflection surface, the second reflection surface, the third reflection surface and the fourth reflection surface are arc.

Further, the first reflection surface, the second reflection surface, the third reflection surface and the fourth reflection surface are caved to the middle of the reflection section.

Further, the first reflection surface and the second reflection surface are arranged symmetrically; the third reflection surface and the fourth reflection surface are arranged symmetrically.

Further, the light guide plate is formed by splicing two sub light guide plates on the lengthwise direction, the reflection section is a reflection layer coated on the terminal surface of the two sub light guide plates.

Possibly, the light guide plate is formed by splicing the two sub light guide plates on the lengthwise direction and a polyhedron structure reflection section between the two sub light guide plates.

Possibly, the light guide plate is formed by splicing the two sub light guide plates on the lengthwise direction and each terminal surface of the sub light guide plates is arranged concavely, the reflection section includes two sub reflectors embedded on the sunken terminal surface of the sub light guide plate respectively, the each sub light guide plate with the corresponding sub reflector composes a combination which terminal surface is flat.

Another object of the present disclosure is to provide a back light used for double-sided display device including the above light guide plate and the both ends of the side-light module thereof.

A further object of the present disclosure is to provide a double-sided display device including the above light guide plate and the both ends of the side-light module and the both sides of the display panel thereof.

Because of the horizontal component emitted by light source module through both sides of the light guide plate in the display device will be changed the transmission direction by the reflection surface, so as to be guided to the both sides of the display panel, and increasing the light utilization emitted by the light source module at least 5%-10%, thus no longer need to raise additional light source brightness, energy-efficient economy, the competitiveness of products have been greatly enhanced.

### BRIEF DESCRIPTION OF THE DRAWINGS

FIG. 1 is a schematic structural view of the prior art double-sided display device.

FIG. 2 is a perspective schematic structural view of the back light of the embodiment 1 of the present disclosure.

FIG. 3 is a schematic structural view of another direction of the back light of the embodiment 1 of the present disclosure.

FIG. 4 is a schematic structural view of the double-sided display device of the embodiment 1 of the present disclosure.

FIG. 5 is a schematic structural view of the back light of the embodiment 2 of the present disclosure.

FIG. 6 is a schematic structural view of the back light of the embodiment 3 of the present disclosure.

### DETAILED DESCRIPTION OF PREFERRED EMBODIMENTS

In order to make the objects, technical solutions and advantages of the present disclosure will become apparent from, the accompanying drawings and the following embodiments, the present disclosure will be described in further detail. It should be understood that the specific embodiments described herein only to explain the present disclosure and are not intended to limit the present disclosure.

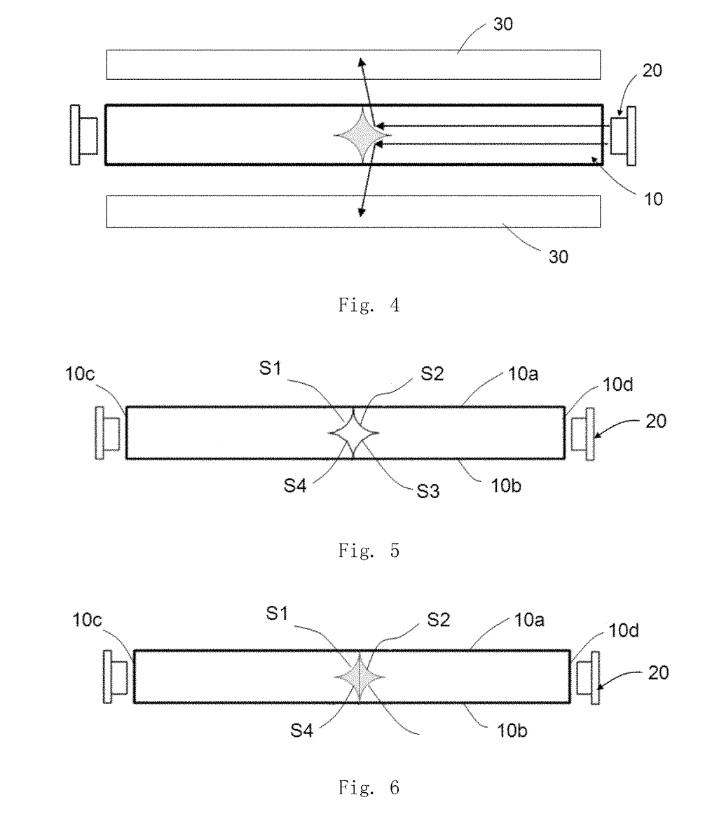

It should be noted that, in order to described the embodiments better, the terms “up”, “low”, “left”, “right” as used herein indicate a positional relationship are referend the placed way in FIG. 4, and here, “lengthwise direction” means the object along the longer direction, “width direction” means the object along the narrow direction and “thickness direction” means the object along the height direction.

### Example 1

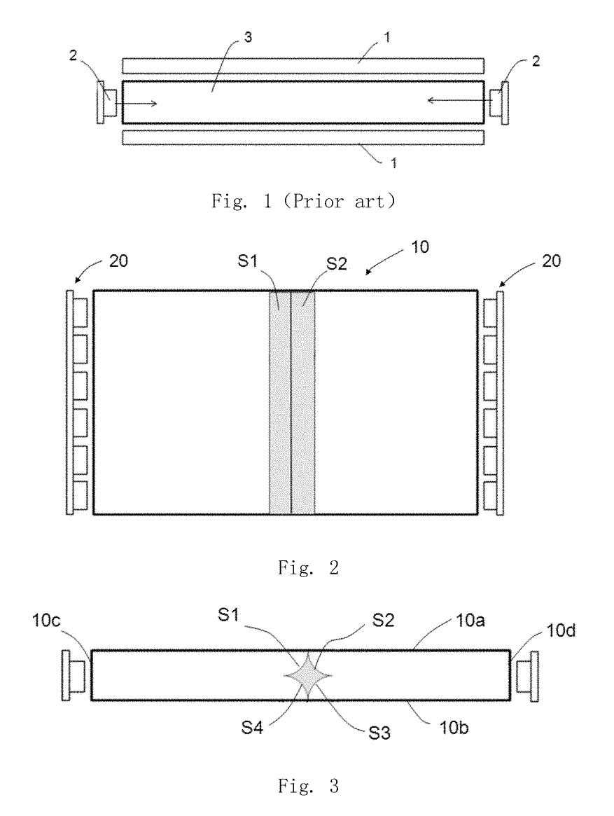

Refer to FIG. 2 and FIG. 3, a back light of the present embodiment includes a light guide plate 10 and both ends of a side-light module 20, the light resource module of the present embodiment is use LED light resource as an example. The light guide plate 10 includes an upper light output surface 10a and a lower surface 10b on the thickness direction and a left light input terminal surface 10c and a right light input terminal surface 10d on the lengthwise direction. The light guide plate further includes a reflection section arranged in the middle (not shown), the reflection section includes a first reflection surface S1 facing to the upper light output surface 10a and the left light input terminal surface 10c, a second reflection surface S2 facing to the upper light output surface 10a and the right light input terminal surface 10d at the same time, a third reflection surface S3 facing to the lower light output surface 10b and the left light input terminal surface 10d at the same time and a fourth reflection surface S4 facing to the lower light output surface 10b and the right light input terminal surface 10c at the same time, the first reflection surface S1, the second reflection surface S2, the third reflection surface S3 and the fourth reflection surface S4 are surrounded end to end to be a close structure, the reflection section completely covers the thickness direction and the lengthwise direction of the light guide plate.

Combine the FIG. 4, in the double-sided display device, the reflection section in the middle has same thickness and width with the light guide plate 10, so that the light emitted by both ends of the light resource module 20 cannot pass through, after the light emitted by the both ends of the light guide plate 20 through the reflection section, the light emitted toward the upper light output surface 10a and the lower light output surface 10b respectively, i.e. the light emitted by the left side of the light resource module 20 to the upper half of the reflection section is emitted from the light output surface 10a after reflecting the first reflection surface S1, the light emitted by the left side of the light resource module 20 to the lower half of the reflection section is emitted from the upper light output surface 10b after reflecting the fourth reflection surface S4, the light emitted by the light emitted by the right side of the light resource 20 to the upper half of reflection section is emitted from the light output surface 10b after reflecting the second reflection surface S2 and the light emitted by the light emitted by the right side of the light resource 20 to the lower half of reflection section is emitted from the light output surface 10b after reflecting the third reflection surface S3 wherein, the first reflection surface S1, the second reflection surface S2, the third reflection surface S3 and the fourth reflection surface S4 are arc, and the first reflection surface S1, the second reflection surface S2, the third reflection surface S3 and the fourth reflection surface S4 are caved to the middle of the reflection section. When the sections of the first reflection surface S1, the second reflection surface S2, the third reflection surface S3 and the fourth reflection surface S4 are quarter arc, the light coverage area is larger after reflected by reflection section and the light uniformity display panel 30 received is higher. It is appreciated, in other embodiments, the first reflection surface S1, the second reflection surface S2, the third reflection surface S3 and the fourth reflection surface S4 can be flat and surrounded a reflection section with diamond section, but the reflex uniformity is weaker than the arcuate reflecting surface.

As an example of the present embodiment, the first reflection surface S1 and the second reflection surface S2 are arranged symmetrically; the third reflection surface S3 and the fourth reflection surface S4 are arranged symmetrically; the first reflection surface S1 and the fourth reflection surface S4 are arranged symmetrically. In this manner ensures that the upper and lower sides of the display panel 30 to display a screen with the same image quality.

To facilitate manufacture and assembly, the reflection section of the present embodiment is a separate polyhedral structure and its outer surface is reflective material, the light guide plate 10 is formed by splicing two sub light guide plates on the lengthwise direction and the polyhedral structure reflection section between the two sub light guide plates, each terminal surface of the sub light guide plate is sunken and is formed by concatenated two convex surfaces expanded upper and lower respectively to wedge the shape of the polyhedron reflection section and ensure the reflective effect.

Because of the horizontal component emitted by light source module through both sides of the light guide plate in the display device will be changed the transmission direction by the reflection surface, so as to be guided to the both sides of the display panel, and increasing the light utilization emitted by the light source module at least 5%-10%, thus no longer need to raise additional light source brightness, energy-efficient economy, the competitiveness of products have been greatly enhanced.

### Example 2

As shown in FIG. 5, the difference from the embodiment 1 is the light guide plate 10 of the present embodiment formed by splicing two sub light guide plates on the lengthwise direction, the reflection section is a reflection layer coated on two terminal surfaces of the sub light guide plate and the space between the two sub light guide plates is hollow or filled up by other materials. This structure can maximize saving the materials and improve the competitiveness of the products.

### Example 3

As shown in FIG. 6, the difference from the embodiment 1 is the light guide plate of the present embodiment formed by splicing two sub light guide plates on the lengthwise direction, each terminal surface of the sub light guide plate arranged sunken, the reflection section including two sub reflectors and embedded on the sunken terminal surface of the sub light guide plate, each sub reflector including a reflection surface facing the light input terminal surface and a flat for bonded to another reflector and the each sub light guide plate and the respective sub reflector composing a planar terminal surface assembly.

The above is only a specific embodiment of the present application, it should be noted that those of ordinary skill in the art, in this application without departing from the principles of the premise, but also a number of improvements and modifications can be made, these improvements and modifications should be considered as the scope of protection of the present application.

What is claimed is:

1. A light guide plate used for double-sided display device comprises an upper light output surface and a lower light output surface on the thickness direction, and a left light input terminal surface and a right light input terminal surface on the lengthwise direction, wherein, the light guide plate further comprises a reflection section in the middle, the reflection section comprises a first reflection surface facing to the upper light output surface and the left light input terminal surface at the same time, a second reflection surface facing to the upper light output surface and the right light input terminal surface at the same time, a third reflection surface facing to the lower light output surface and the left light input terminal surface at the same time and a fourth reflection surface facing to the lower light output surface and the right light input terminal surface at the same time, the first reflection surface, the second reflection surface, the third reflection surface and the fourth reflection surface are surrounded end to end to be a close structure, the reflection section completely covers the thickness direction and the lengthwise direction of the light guide plate.

2. The light guide plate according to claim 1, wherein the first reflection surface, the second reflection surface, the third reflection surface and the fourth reflection surface are arc.

3. The light guide plate according to claim 2, wherein the first reflection surface, the second reflection surface, the third reflection surface and the fourth reflection surface are caved to the middle of the reflection section.

4. The light guide plate according to claim 3, wherein the first reflection surface and the second reflection surface are arranged symmetrically; the third reflection surface and the fourth reflection surface are arranged symmetrically.

5. The light guide plate according to claim 4, wherein the first reflection surface and the fourth reflection surface are arranged symmetrically.

6. The light guide plate according to claim 1, wherein the light guide plate is formed by splicing two sub light guide plates, the reflection section is a reflection layer coated on the terminal surface of the two sub light guide plates.

7. The light guide plate according to claim 1, wherein the light guide plate is formed by splicing the two sub light guide plates on the lengthwise direction and the reflection section of polyhedron structure between the two sub light guide plates.

8. The light guide plate according to claim 1, wherein the light guide plate is formed by splicing the two sub light guide plates on the lengthwise direction and each terminal surface of the sub light guide plate is arranged concavely, the reflection section comprises two sub reflectors embedded on the sunken terminal surface of the sub light guide plate respectively, the each sub light guide plate with the corresponding sub reflector composes a combination which terminal surface is flat.

9. A back light for the double-sided display device, wherein comprises the light guide plate and a side-light module of both ends of the light guide plate according to claim 1.

10. The back light according to claim 9, wherein the first reflection surface, the second reflection surface, the third reflection surface and the fourth reflection surface are arc.

11. A double-sided display device comprises a light guide plate and both ends of the side-light module and both sides of display panel, the light guide plate comprises an upper light output surface and a lower light output surface on the thickness direction and a left light input terminal surface and a right light input terminal surface on the lengthwise direction, wherein the light guide plate further comprises a reflection section arranged in middle, the reflection section comprises a first reflection surface facing to the upper light output surface and the left light input terminal surface at the same time, a second reflection surface facing to the upper light output surface and the right light input terminal surface at the same time, a third reflection surface facing to the lower light output surface and the left light input surface at the same time and a fourth reflection surface facing to the lower light output surface and the right light input terminal surface at the same time, the first reflection surface, the second reflection surface, the third reflection surface and the fourth reflection surface are surrounded end to end to be a close structure, the reflection section completely covers the thickness direction and the lengthwise direction of the light guide plate.

12. The double-sided display device according to claim 11, wherein the first reflection surface and the second reflection surface, the third reflection surface and the fourth reflection surface are arc.

13. The double-sided display device according to claim 12, wherein the first reflection surface, the second reflection surface, the third reflection surface and the fourth reflection surface are caved to the middle of the reflection section.

14. The double-sided display device according to claim 13, wherein the first reflection surface and the second reflection surface are arranged symmetrically; the third reflection surface and the fourth reflection surface are arranged symmetrically.

15. The double-sided display device according to claim 14, wherein the first reflection surface and the fourth reflection surface are arranged symmetrically.

16. The double-sided display device according to claim 11, wherein the light guide plate is formed by splicing two sub light guide plates on the lengthwise direction, the reflection section is a reflection layer coated on the terminal surface of the two sub light guide plates.

17. The double-sided display device according to claim 11, wherein the light guide plate is formed by splicing the two light guide plates on the lengthwise direction and the polyhedral structure reflection section between two sub light guide plates.

18. The double-sided display device according to claim 11, wherein the light guide plate is formed by splicing the two sub light guide plates on the lengthwise direction, each terminal surface of the sub light guide plate is arranged concavely, the reflection section comprises two sub reflectors embedded a sunken terminal surface of the sub light guide plate, each sub light guide plate with the corresponding sub reflector composes a combination which terminal surface is flat.

19. The double-sided display device according to claim 12, wherein the light guide plate is formed by splicing two sub light guide plates on the lengthwise direction, each terminal surface of the sub light guide plate are arranged concavely, the reflection section comprises two sub reflectors embedded on the sunken terminal surface of the sub light guide plate, the each sub light guide plate with the corresponding sub reflector composes a combination which terminal surface is flat.
